(19) United States
(12) Patent Application Publication
(10) Pub. No.: US 2025/0093742 A1
(43) Pub. Date: Mar. 20, 2025

(54) IMAGING SYSTEM AND MOBILE OBJECT PROVIDED WITH SAME

(71) Applicant: Panasonic Intellectual Property Management Co., Ltd., Osaka (JP)

(72) Inventors: Satoshi MATSUI, Kyoto (JP); Norikazu KATSUYAMA, Osaka (JP)

(21) Appl. No.: 18/964,114

(22) Filed: Nov. 29, 2024

Related U.S. Application Data
(63) Continuation of application No. PCT/JP2023/020304, filed on May 31, 2023.

(30) Foreign Application Priority Data
Jun. 1, 2022 (JP) 2022-089868

(51) Int. Cl. G03B 5/00; G03B 17/56

(52) U.S. Cl. CPC G03B 5/00; G03B 17/561; G03B 2205/0023

(57) ABSTRACT

An imaging system includes an imaging device performing imaging in a first imaging state and a second imaging state of different optical axes, an attitude detector that detects an attitude change amount of the mobile object, an optical axis changing assembly that changes, while the mobile object is moving in a first direction, an optical axis of the imaging device from a state of a first optical axis at a time when the imaging device performs imaging in the first imaging state to a state of a second optical axis inclined in a second direction intersecting the first direction at a time of imaging in the second imaging state, and a controller that sets an optical axis change amount by which the optical axis changing assembly changes the optical axis of the imaging device, based on the attitude change amount.

### CROSS-REFERENCE TO RELATED APPLICATIONS

This is a continuation application of International Application No. PCT/JP2023/020304, with an international filing date of May 31, 2023, which claims priority of Japanese Patent Application No. 2022-089868 filed on Jun. 1, 2022, the content of which is incorporated herein by reference.

### BACKGROUND

### Technical Field

The present disclosure relates to an imaging system that is fixed to a mobile object and performs imaging while the mobile object is moving, and the mobile object provided with the imaging system.

### Background Art

With the aging of transportation infrastructure, the demand for infrastructure inspection is increasing. The inspection efficiency is remarkably improved by imaging the infrastructure facility during movement with a mobile object and detecting a defective portion on the captured image with image processing instead of the visual inspection by a person.

For example, in WO 2015/060181 A, a camera installed in a vehicle captures an image of a target region during moving. Further, in a case where the traveling speed of the vehicle is high, a blur due to camera movement occurs, but in WO 2015/060181 A, the blur due to movement is corrected using a technique of a saccade mirror. The blur is reduced by irradiating an imaging target with light, by reflecting the light reflected from the imaging target from a mirror, and by injecting the light to the camera. The mirror rotates for a predetermined exposure time.

### SUMMARY

However, in a case where a high-resolution image is captured, a lens having a long focal length is used, and thus, the angle of view becomes small. This makes the imaging range narrow. When the attitude of the vehicle itself changes, overlapping regions of the captured images are separated, and a continuous image cannot be captured in some cases.

The present disclosure provides an imaging system that is capable of expanding the imaging range and secures the continuity of captured images, and a mobile object having the imaging system.

An imaging system of the present disclosure includes a speed detector that detects a moving speed of a mobile object, an imaging device disposed in the mobile object, the imaging device performing imaging in a first imaging position and a second imaging position of different optical axes, an attitude detector that detects an attitude change amount of the mobile object, an optical axis changing assembly that changes, while the mobile object is moving in a first direction, an optical axis of the imaging device from a state of a first optical axis at a time when the imaging device performs imaging in the first imaging position to a state of a second optical axis displaced in a second direction intersecting the first direction at a time of imaging in the second imaging position, and a controller that sets an optical axis change amount by which the optical axis changing assembly changes the optical axis of the imaging device, based on the attitude change amount. The optical axis changing assembly changes the optical axis of the imaging device based on the set optical axis change amount.

Further, the mobile object of the present disclosure includes the above-described imaging system.

According to the imaging system and the mobile object having the same of the present disclosure, it is possible to provide the imaging system that is capable of expanding the imaging range and secures the continuity of captured images, and the mobile object having the same.

### BRIEF DESCRIPTION OF DRAWINGS

FIG. 1 is a side view for explaining a vehicle including an imaging system according to a first embodiment.

FIG. 2 is a front view for explaining the vehicle including the imaging system according to the first embodiment.

FIG. 3 is a block diagram illustrating an internal configuration of the imaging system according to the first embodiment.

FIGS. 4A and 4B are explanatory diagrams explaining states of the imaging device in respective states of two optical axes in the first embodiment.

FIG. 5 is an explanatory diagram illustrating images captured in a first imaging mode.

FIG. 6 is an explanatory diagram illustrating images captured in a second imaging mode.

FIGS. 7A and 7B are explanatory diagrams for explaining an imaging expansion range with the imaging device in the states of the two optical axes.

FIG. 8 is a flowchart illustrating imaging processing in the first embodiment.

FIG. 9A-9F are graphs illustrating a relationship between a change in a moving speed, a timing of an exposure time, and a change of an optical axis in the first embodiment.

FIG. 10 is a diagram for explaining a vehicle including an imaging system according to a second embodiment.

FIGS. 11A and 11B are explanatory diagrams explaining states of the imaging device in respective states of two optical axes in the second embodiment.

FIG. 12 is a block diagram illustrating an internal configuration of the imaging system according to the second embodiment.

FIG. 13 is an explanatory diagram explaining a blur correction of the imaging system.

FIG. 14 is a flowchart illustrating imaging processing in the second embodiment.

FIG. 15A-15F are graphs illustrating a relationship between a change in a moving speed, a timing of an exposure time, and a change of an optical axis in the second embodiment.

FIG. 16 is a block diagram illustrating an internal configuration of an imaging system according to a third embodiment.

FIG. 17 is a flowchart illustrating imaging processing in the third embodiment.

FIG. 18 is a block diagram illustrating an internal configuration of an imaging system according to a fourth embodiment.

FIG. 19 is a block diagram illustrating an internal configuration of the imaging system according to the fourth embodiment.

### DETAILED DESCRIPTION

### First Embodiment

A first embodiment will be described below with reference to the drawings. The first embodiment describes a case where the mobile object is a vehicle 3 such as an automobile and an imaging system 1 is attached to an upper portion of the vehicle 3 as an example. The imaging system 1 of the first embodiment is disposed to image a wall 5 built on the side a road as an example. The wall 5 is, for example, a soundproof wall or a tunnel wall.

### [1-1. Configuration of Imaging System]

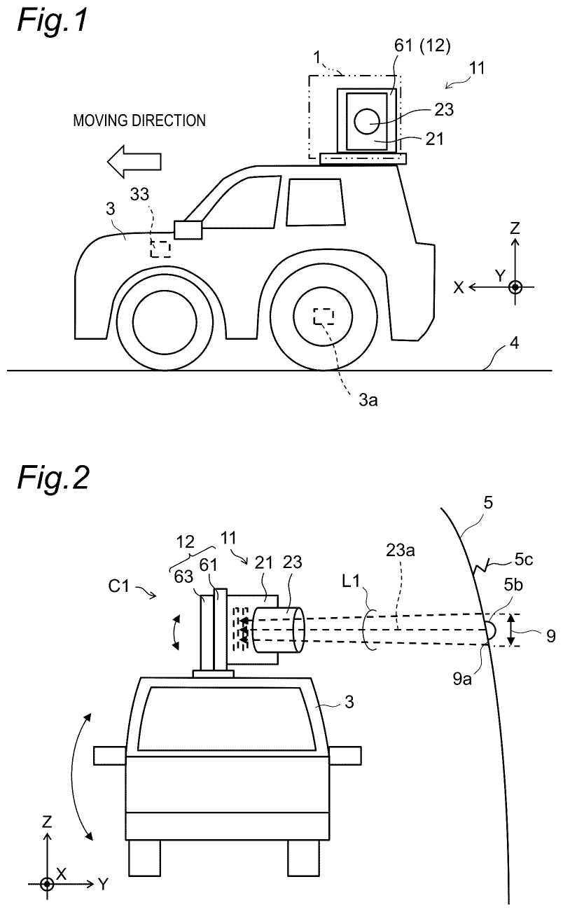

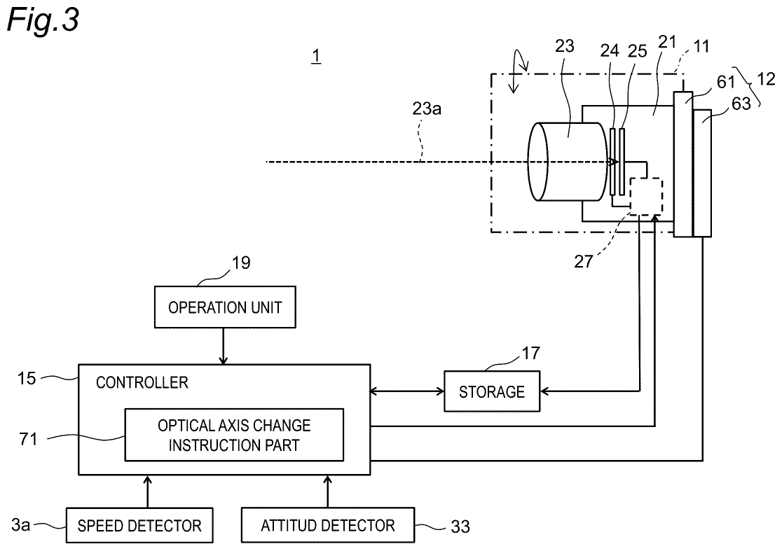

FIGS. 1 to 3 are referred to. FIGS. 1 and 2 are diagrams for explaining the imaging system 1. FIG. 3 is a block diagram illustrating an internal configuration of the imaging system 1. In FIGS. 1 and 2, the vehicle 3 is traveling on a road 4, for example. For example, a hole 5b or a crack 5c is generated in the wall 5 built on the side of the road 4. The hole 5b and crack 5c can be detected in the captured image with image processing.

An imaging target of the imaging system 1 is at least a part of a structure around the vehicle 3, and is a target that relatively moves in accordance with a moving speed of the vehicle 3 when the vehicle 3 moves. An imaging target region 9 is a region acquired as an image in the imaging target. The imaging target may include, in addition to the wall 5, a road, a side surface or a bottom surface of a bridge, a utility pole, or an electric wire. This makes it possible to detect, in the acquired image, a hole, a crack, lifting, peeling, and a joint of the imaging target, an inclination of a utility pole, and deflection of an electric wire with the image processing.

The imaging system 1 is installed on an upper surface of the vehicle 3. The imaging system 1 is fixed to capture an image of the wall 5 beside the vehicle 3 in FIG. 1.

The imaging system 1 includes a speed detector 3a, an imaging device 11, an optical axis changing assembly 12, a controller 15, and an attitude detector 33. The imaging device 11 captures an image of a periphery of the vehicle 3, and images a wall surface 5a of the wall 5 in the first embodiment. The imaging device 11 includes a camera body 21, a lens 23, a shutter 24, an imaging element 25, and a camera controller 27.

The speed detector 3a, which is disposed in the vehicle 3, detects the moving speed of the vehicle 3. This makes it possible to further detect that the vehicle 3 is moving. In the first embodiment, the speed detector 3a detects the moving speed based on a vehicle speed pulse signal. The vehicle speed pulse signal is switched to ON or OFF at each constant rotation amount (rotation angle) of the axle of the vehicle 3. The speed detector 3a transmits the vehicle speed pulse signal as well as the detected moving speed to the controller 15. In addition to this type of the detector, the speed detector 3a may be, for example, a vehicle speed sensor that detects the moving speed based on the rotation speed of the axle of the vehicle 3. The controller 15 may detect the moving speed based on the vehicle speed pulse signal.

The lens 23 is attached to the camera body 21 to be replaceable. The camera body 21 accommodates the imaging element 25 and the camera controller 27. The imaging element 25 is disposed at a position of a focal length F of the lens 23. The direction of the lens 23 directly faces the wall 5 that is a subject. The camera body 21 and the lens 23 may be integrated. The imaging element 25 converts received light into an electric signal depending on intensity. The imaging element is a solid-state imaging element, such as a charge-coupled device (CCD) image sensor, a complementary metal oxide semiconductor (CMOS) image sensor, or an infrared image sensor.

The camera controller 27 opens the shutter 24 while receiving an exposure instruction signal from the controller 15. The shutter 24 may be configured to open and close a plurality of blade diaphragms, or may be an electronic shutter. The camera body 21 is supported to a base 61. The base 61 is rotatably supported on the upper surface of the vehicle 3 with the traveling direction of the vehicle 3 being a rotation axis. The controller 15 may generate an exposure instruction signal based on the vehicle speed pulse signal received from the speed detector 3a, and transmit the signal to the camera controller 27.

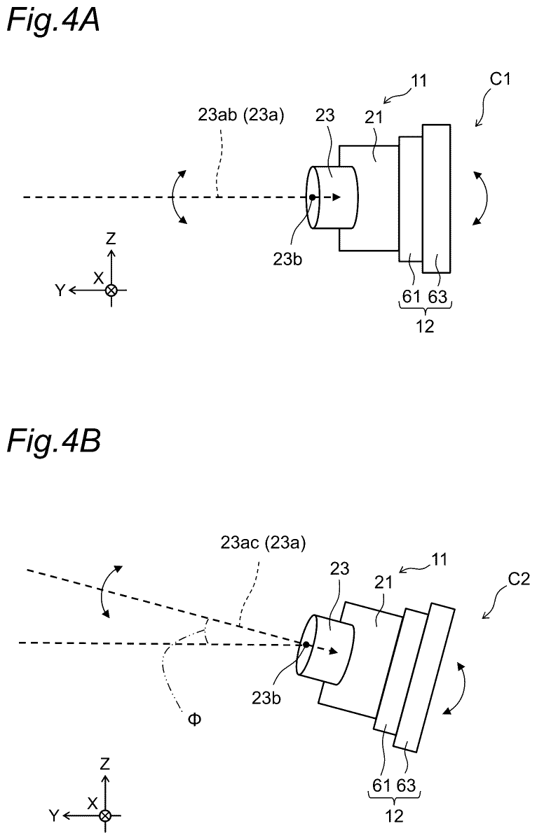

When the imaging device 11 performs imaging while the vehicle 3 is moving in a first direction that is a +X-axis direction, the optical axis changing assembly 12 changes an optical axis 23a of the lens 23 in the lens 23 of the imaging device 11. At this time, the optical axis changes from a state of a first optical axis 23ab directed perpendicularly toward the wall at a time of capturing a first image to a state of a second optical axis 23ac (see FIGS. 4A and 4B) inclined in a second direction that is a +Z-axis direction intersecting the first direction at a time of capturing a second image. The optical axis changing assembly 12 can change the optical axis 23a of the lens 23 in the same direction as a roll direction of the vehicle 3. The optical axis changing assembly 12 includes the base 61 and a rotation drive 63.

The base 61 supports the camera body 21. Note that the imaging device 11 may be configured so that the camera body 21, the lens 23, and the optical axis changing assembly 12 are integrated.

The rotation drive 63 rotationally drives the base 61 based on a rotation instruction from the controller 15. The rotation drive 63 includes, for example, a motor and a gear. As the base 61 rotates, the camera body 21 rotate accordingly. The optical axis changing assembly 12 may include, for example, a rotation stage, and may rotate the imaging device 11 with the rotation stage.

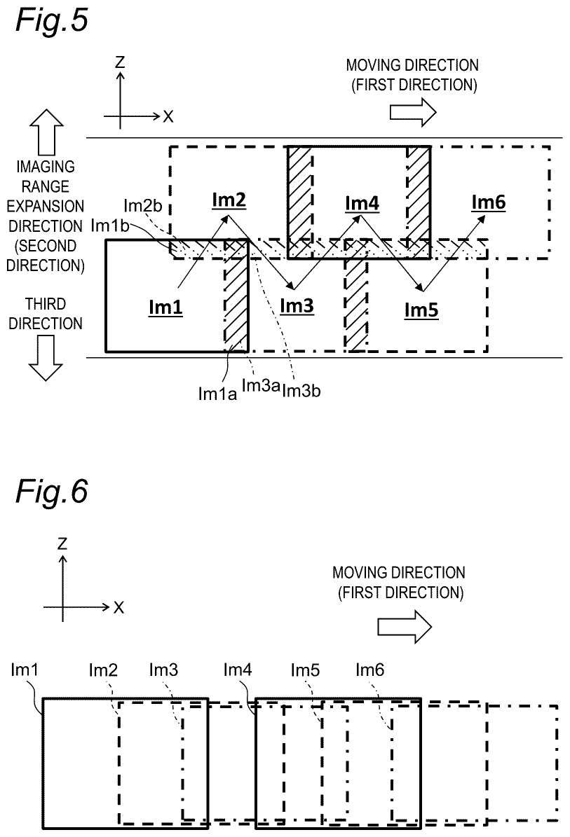

FIGS. 4A and 4B are referred to. FIGS. 4A and 4B are explanatory diagrams for explaining the imaging device 11 in the states of two types of optical axes. FIG. 4A is the explanatory diagram illustrating the imaging device 11 in a first imaging state C1 where the lens 23 is in the state of the first optical axis 23ab. FIG. 4B is the explanatory diagram illustrating the imaging device 11 in a second imaging state C2 where the lens 23 is in the state of the second optical axis 23ac. The imaging device 11 can be displaced between the first imaging state C1 illustrated in FIG. 4A and the second imaging state C2 illustrated in FIG. 4B by driving the rotation drive 63. The optical axis changing assembly 12 rotates the imaging device 11 about the principal point 23b of the lens 23 as a rotation center, for example. This makes, as illustrated in FIG. 5, it possible to expand the imaging range of the imaging device 11 in the second direction which is a +Z-axis direction intersecting the first direction at the time of capturing the second image.

For example, when the imaging device 11 is in the first imaging state C1, a first image Im1 (see FIG. 5) is captured. After completion of capturing the image Im1, the imaging device 11 is displaced to the second imaging state C2 to capture an image Im2. After the image Im2 is captured, an optical axis 23a of the lens 23 is inclined in a third direction that is a-Z-axis direction, namely, to the state of the first optical axis 23ab. As a result, the imaging device 11 is displaced to the first imaging state C1 to capture an image Im3. As described above, the imaging device 11 images the wall 5 while being alternately displaced between the first imaging state C1 and the second imaging state C2. In this way, the imaging device 11 captures a fourth image Im4, a fifth image Im5, and a sixth image Im6. This makes it possible to image a wider range of the wall 5. A mode in which the imaging device 11 is displaced to perform imaging in this manner is referred to as a first imaging mode.

In the first imaging mode, an end region Im3a on the opposite side to the moving direction in the third captured image Im3 is imaged so as to overlap with an end region Im1a in the moving direction in the first captured image Im1. Imaging is performed so that an end region Im1b in the second direction (+Z-axis direction) in the first captured image Im1 overlaps with an end region Im2b in the third direction (−Z-axis direction) in the second captured image Im2. The third direction is opposite to the second direction. Further, imaging is performed so that an end region Im2b in the third direction (−Z-axis direction) in the second captured image Im2 overlaps with an end region Im3b in the second direction (+Z-axis direction) in the third captured image Im3. As described above, the first captured image Im1 and the second captured image Im2 have the common imaging region. Further, the second captured image Im1, the second captured image Im2, and the third captured image Im3 each have the common imaging region. Similarly, by sequentially capturing the images Im4, Im5, and Im6, these images have imaging regions overlapping each other in adjacent images. Further, the wall 5 may be imaged without any gaps in adjacent images. In either case, imaging omission between images can be prevented.

The imaging system 1 may have a second imaging mode in which the images Im1 to Im6 are captured while the first imaging state C1 is being maintained without displacing the imaging device 11. In this case, as illustrated in FIG. 6, captured images can be continuously acquired in a line. In FIG. 6, the widths of the images Im1 to Im6 in the Z-axis direction are different for easy understanding, but the actual widths are the same. Further, in the second imaging mode, for example, the imaging region of the image Im2 is entirely included in the imaging regions of the image Im1 and the image Im3. Therefore, the image Im2 does not have to be captured. That is, the imaging may be performed by skipping one image, like images Im1, Im3, and Im5.

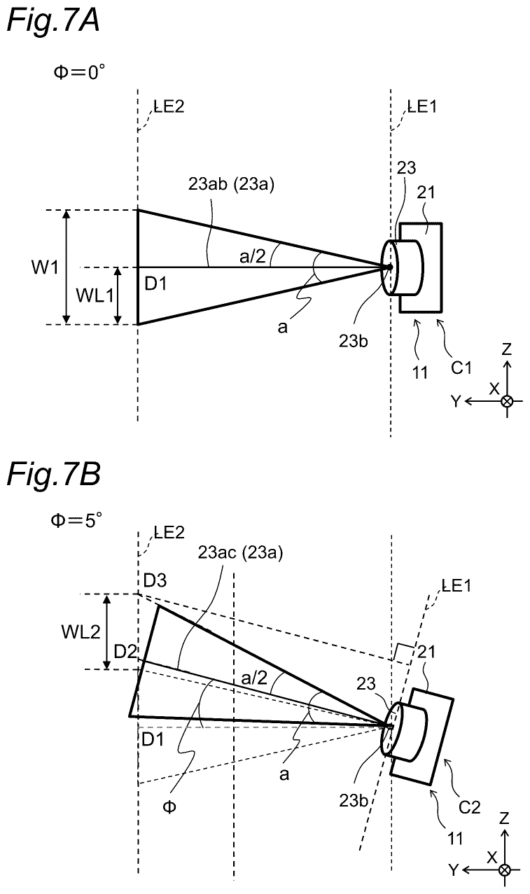

The expansion amount of the imaging range in the first imaging mode will be described with reference to FIGS. 7A and 7B. FIGS. 7A and 7B are explanatory diagrams for explaining the expansion amount of the imaging range. FIG. 7A is the explanatory diagram illustrating a state before an optical axis change (Φ=0°). FIG. 7B is the explanatory diagram illustrating a state after the optical axis change (Φ=5°).

A distance between an extension line LE1 (extension line of an imaging plane) of the principal point of the lens 23 in the Z-axis direction and an extension line LE2 of an imaging target surface 9a in the Z-axis direction will be described. In the first embodiment, the imaging target surface 9a is the surface of the wall 5.

It is assumed that the vertical size of the imaging element 25 is 7.03 [mm], the focal length F of the lens 23 is 35 [mm], and a first subject distance D1, which is the distance to the wall 5 in a case where the optical axis of the imaging device 11 is at an initial position (optical axis change angle Φ=0), is 1.7 [m]. At this time, the angle of view a is 11.47 [deg], and a vertical imaging range W1 (=2×WL1) is 0.34 [m]. The vertical imaging range W1 is calculated according to the following Equation (1).

$$W 1 = 2 \times WL 1 = 2 \times D 1 \times tan ( a / 2 ) \qquad Equation ( l )$$

An expansion amount WL2 is calculated using the optical axis change angle Φ according to the following Equation (2). The optical axis change angle Φ is an angle through which the optical axis is rotated from the first optical axis 23ab by changing the optical axis.

$$W 2 = D 1 \times tan \{ ( Φ + ( a / 2 ) \} - D 1 \times tan ( a / 2 ) \qquad Equation ( 2 )$$

In a case where the optical axis change angle Φ is 5 [deg], the expansion amount WL2 is 0.15 [m], and the imaging range is expanded by about 44% in the vertical direction.

Here, the optical axis change angle Φ≤the angle of view a. As a result, the image captured in the state of the first optical axis 23ab and the image captured in the state of the second optical axis 23ac may be continuous without a gap or may have an overlapping region. Note that the optical axis change angle used for the first optical axis change for expanding the imaging range of the captured image is expressed by Φ1. A first optical axis change angle Φ1 may be a predetermined angle designated by a user using an operation unit 19, or may be determined by the controller 15 based on the distance to the imaging target region and the angle of view a of the imaging device 11.

FIG. 3 is referred to. The attitude detector 33 detects the attitude change amount in the expansion direction of the imaging range with respect to the reference attitude of the vehicle 3. The attitude detector 33 is, for example, a gyro sensor or an acceleration sensor. The detected attitude change amount is output to the controller 15. In the first embodiment, the attitude detector 33 detects at least an attitude change amount γ of the vehicle 3 in the roll direction with respect to the horizontal direction. The attitude detector 33 may detect an attitude change amount in a yaw direction or a pitch direction in addition to the roll direction.

The controller 15 controls the exposure time of the imaging device 11 and the driving of the optical axis changing assembly 12, and operates the optical axis changing assembly 12 between a timing of capturing the first image and a timing of capturing the second image. The controller 15 sets an optical axis change amount by which the optical axis changing assembly 12 changes the optical axis of the imaging device 11, based on the detected attitude change amount.

The controller 15 is a circuit that can be implemented by a semiconductor element or the like. The controller 15 may include, for example, a microcomputer, a central processing unit (CPU), a microprocessor unit (MPU), a graphic processing unit (GPU), a digital signal processor (DSP), a field programmable gate array (FPGA), or an application-specific integrated circuit (ASIC). The function of the controller 15 may be configured by hardware alone, or may be achieved by combining hardware and software. The controller 15 reads data and programs stored in a storage 17 and performs various arithmetic processing to implement a predetermined function.

The controller 15 includes an optical axis change instruction part 71. The optical axis change instruction part 71 instructs the rotation drive 63 of the optical axis changing assembly 12 to change the state of the optical axis, for example, at the timing of receiving the speed detection of the vehicle 3 using the speed detector 3a or the timing of capturing an image using the imaging device 11 at a constant frame rate, in accordance with the attitude change amount of the vehicle 3 detected by the attitude detector 33. The optical axis change instruction part 71 issues two types of instructions to change the optical axis: the first optical axis change for expanding the imaging range of a captured image; and the second optical axis change for offsetting the influence of the attitude change of the vehicle 3.

In the first optical axis change, the optical axis change instruction part 71 instructs the optical axis changing assembly 12 to change the optical axis in accordance with the imaging cycle. The optical axis change instruction part 71 always issues the instruction of the second optical axis change except during the first optical axis change. When the attitude change amount of the vehicle 3 in the roll direction is input from the attitude detector 33 to the controller 15, the optical axis change instruction part 71 calculates a second optical axis change angle Φ2 at which the input attitude change amount in the roll direction is offset, and instructs the optical axis changing assembly 12 to rotate the optical axis by the second optical axis change angle Φ2 in the roll direction. The second optical axis change angle Φ2 is an angle used for changing to the second optical axis in order to offset the influence of the attitude change of the vehicle 3. The second optical axis change angle Φ2 is an angle amount opposite in sign to the attitude change amount. The optical axis change angle Φ is the sum of the first optical axis change angle Φ1 and the second optical axis change angle Φ2 (Φ=Φ1+Φ2). When the attitude change amounts in the yaw direction and the pitch direction are further input to the controller 15, the optical axis change instruction part 71 may further calculate an optical axis change angle at which the attitude change amount in the roll direction affected by the attitude change amounts in the yaw direction and the pitch direction is offset, and may instruct the optical axis changing assembly 12 to further rotate the optical axis in the roll direction by this optical axis change angle.

The controller 15 transmits an exposure control signal to the camera controller 27. The exposure control signal includes two types of signals, an Hi signal as an ON signal for instructing exposure and a Low signal as an OFF signal for not instructing exposure. In a case where imaging is performed at a constant frame rate, the camera controller 27 may control exposure instead of the controller 15.

The imaging system 1 further includes a storage 17 and an operation unit 19. The storage 17 is a storage medium that stores programs and data necessary for implementing the functions of the controller 15. The storage 17 can be implemented by, for example, a hard disk (HDD), a solid-state disk (SSD), a random access memory (RAM), a dynamic random access memory (DRAM), a ferroelectric memory, a flash memory, a magnetic disk, or a combination thereof.

The operation unit 19 is an input device for the user to instruct the controller 15. The operation unit 19 may be an input device such as a keypad or touch panel dedicated to the imaging system 1 or a mobile terminal such as a smartphone. In a case where a mobile terminal is used as the operation unit 19, the operation unit 19 and the controller 15 transmit and receive data via wireless communication. The user may use the operation unit 19 to instruct the controller 15 to determine that the imaging target region is an indoor dark region, such as a tunnel, or an outdoor bright region, such as a slope of a mountain or a road, or to determine a capturing interval Tf. The capturing interval Tf is a time between a timing at which capturing of a current image is completed and a timing at which capturing of a next image is completed. In a case of capturing a moving image, the capturing interval Tf is one frame time, and in a case of capturing a still image, it is a time interval of image capturing times. In the case of capturing a moving image, a frame rate (the number of images to be captured per second) may be designated. Further, the user may use the operation unit 19 to instruct the controller 15 to switch between the first imaging mode for operating the optical axis changing assembly 12 and the second imaging mode for not operating the optical axis changing assembly 12.

### [1-2. Operation of Imaging System]

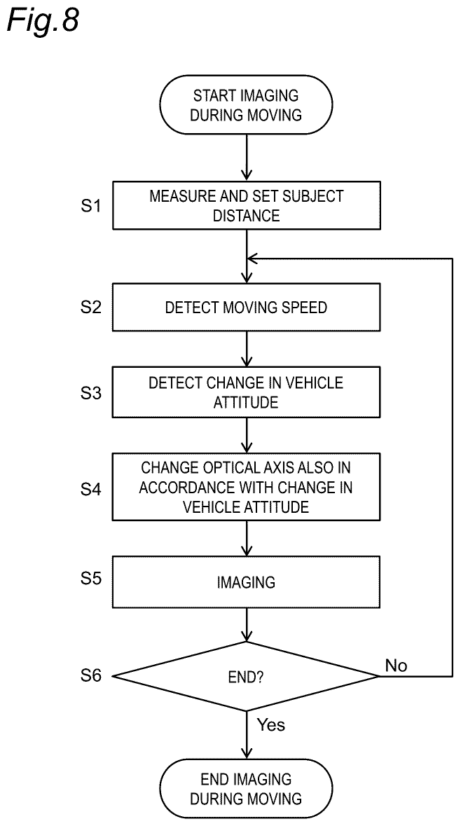

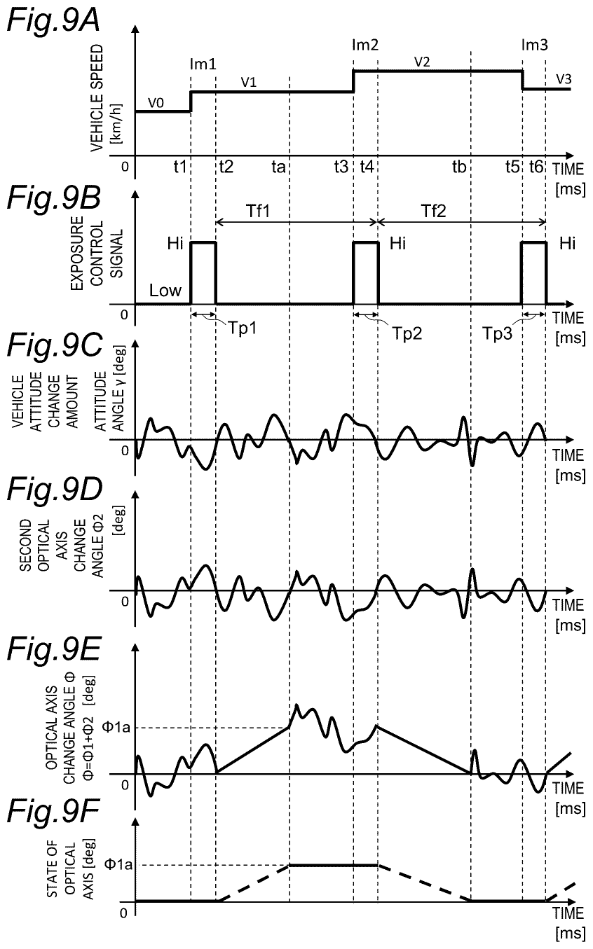

The operation of the imaging system 1 will be described below with reference to FIGS. 8 and 9A-9F. FIG. 8 is a flowchart illustrating imaging processing performed by the imaging system 1. FIG. 9A-9F are graphs illustrating a relationship between the exposure time and the optical axis change timing. FIG. 9A is the graph illustrating the moving speed of the vehicle 3. The moving speed changes with the lapse of time. The moving speeds V0, V1, V2, and V3 are detected in accordance with the timing of detecting the vehicle speed. FIG. 9B is the graph illustrating the timing of the exposure time at each frame. Capturing intervals Tf1 and Tf2 for respective images are indicated as the capturing interval Tf, and exposure times Tp1, Tp2, and Tp3 for respective images as the exposure time Tp. The exposure times Tp1, Tp2, and Tp3 are times from imaging start times t1, t3, and t5 to imaging end times t2, t4, and t6, respectively. FIG. 9C is the graph illustrating the attitude change amount of the vehicle 3 detected by the attitude detector 33. FIG. 9D is the graph illustrating the second optical axis change angle Ø2 calculated by the controller 15. FIG. 9E is the graph illustrating the optical axis change angle Φ instructed by the optical axis change instruction part 71 to the rotation drive 63. FIG. 9F is the graph illustrating a state of the optical axis of the imaging device 11B rotated by the rotation drive 63 as viewed from the imaging target region 9. The imaging processing illustrated in FIG. 8 is started, for example, when the instruction to start imaging is issued from the operation unit 19 while the vehicle 3 is moving.

In step S1, a user measures in advance a subject distance from the imaging element 25 of the camera body 21 to the wall surface of the wall 5 as the imaging target, and sets the measured subject distance for the controller 15 using the operation unit 19. Further, by setting the section of the road to be imaged, for example, the controller 15 can determine whether the vehicle has traveled on the road in the set section, based on global positioning system (GPS) information and a traveling distance.

In step S2, the vehicle 3 starts traveling, and the speed detector 3a detects the moving speed of the vehicle 3. The detected moving speed is sent to the controller 15. In the first embodiment, the imaging is performed in synchronization with the detection of the speed using the speed detector 3a, but the imaging may be performed at a predetermined cycle, or the user may set the imaging cycle with the operation unit 19. A case where the exposure is synchronized with the vehicle speed pulse is described. For example, in a case where the speed is detected at intervals of 40 cm of the moving distance of the vehicle 3 and the traveling speed is 60 km/h, the frame rate becomes about 40 fps. Further, the speed detector 3a does not have to detect an accurate moving speed, and may detect that the vehicle is moving. The detected moving state is sent to the controller 15. In addition to the instruction to start the imaging from the user using the operation unit 19, the controller 15 may perform the imaging after detecting that the vehicle 3 is in the moving state.

In step S3, the attitude detector 33 detects the attitude change amount. As illustrated in FIG. 9C, the attitude detector 33 may always detect the attitude change amount while the vehicle 3 is traveling. The detected attitude change amount is transmitted from the attitude detector 33 to the controller 15. The optical axis change instruction part 71 of the controller 15 calculates the second optical axis change angle Φ2 which is opposite in sign to and is equal in magnitude to the input attitude change amount Y (see FIG. 9D).

In step S4, when the number of images to be captured next is two or more, the optical axis change instruction part 71 of the controller 15 instructs the rotation drive 63 of the optical axis changing assembly 12 to cause a rotation as the first optical axis change. As a result, as illustrated in FIG. 9E, during the period from time t2 to time ta, the imaging device 11 is rotated by the first optical axis change angle Φ1a from the state of the first optical axis 23ab (Φ1=0 [deg]) to the state of the second optical axis 23ac (Φ1=Φ1a [deg]), and the imaging range of the imaging device 11 is changed. In the case of capturing the first image, the optical axis change instruction part 71 may not instruct the rotation drive 63 to cause a rotate (Φ1=0 [deg]). While the rotation drive 63 is changing the optical axis of the imaging device 11 with the first optical axis change (from time t2 to time ta, between time t4 and time tb), the controller 15 does not issue the exposure instruction to the camera controller 27.

Further, while the optical axis change for changing the imaging range (the first optical axis change) is not in operation (from time 0 to time t2, from time ta to time t4, and from time tb to time t6), the optical axis change instruction part 71 instructs the rotation drive 63 of the optical axis changing assembly 12 to cause a rotation (the second optical axis change) in a direction where the attitude change amount is offset. Therefore, the rotation drive 63 performs a drive operation at the optical axis change angle Φ (Φ=Φ1+Φ2) that is the sum of the first optical axis change angle Φ1 and the second optical axis change angle Φ2. As a result, as illustrated in FIG. 9F, the optical axis can be held in the state of the first optical axis 23ab (Φ=0) and the state of the second optical axis 23ac (Φ=Φ1a) during time ta to time t4, and during time tb to time t6 even if the attitude of the vehicle 3 varies during time 0 to time t2. During these time periods, the optical axis changing operation is not performed for the first optical axis change. Therefore, even if an attitude change occurs in the vehicle 3 during exposure, the state where the optical axis has been changed to a desired optical axis can be maintained, and overlapping regions of captured images can be secured. As described above, even in each of the states of the first optical axis 23ab and the second optical axis 23ac, the optical axis can be changed in accordance with the change in the vehicle attitude.

After the optical axis change operation of the rotation drive 63 in the first optical axis change is completed at time ta, in step S5, the controller 15 continues to send, for example, a Hi signal to the camera controller 27 of the imaging device 11 during the exposure time Tp2. As a result, the imaging element 25 images the imaging target for the exposure time Tp2 in a state where the optical axis changing assembly 12 has made the second optical axis change. The image captured by the imaging element 25 is recorded from the camera controller 27 to the storage 17 to acquire the captured image. As described above, the controller 15 does not issue the instruction to make the second optical axis change while the optical axis changing assembly 12 is making the first optical axis change (between time t2 and time ta), but issues the instruction to make the second optical axis change while the imaging device 11 is performing exposure (from time t1 to time t2, from time t3 to time t4, from time t5 to time t6).

In step S6, the controller 15 determines whether the vehicle 3 has traveled in a predetermined section. When the controller 15 determines that the vehicle 3 has finished traveling in the predetermined section, the image acquisition of the road in this section ends. The controller 15 then ends the imaging during moving. Alternatively, when the user operates the operation unit 19, the controller 15 may end the imaging during moving according to the instruction from the operation unit 19. When determining that the vehicle 3 has not finished traveling in the predetermined section, the controller 15 returns to step S2 to perform the imaging during moving again. As a result, in a case where step S3 is executed and the third image is captured, in step S4, as illustrated in FIG. 9E, during time t4 to time tb, the imaging device 11 is rotated by a first optical axis change angle-Φ1a from the state of the second optical axis 23ac (Φ1=Φ1a [deg]) to the state of the first optical axis 23ab (Φ1=0 [deg]). Thus, the imaging range of the imaging device 11 is changed. Thereafter, driving is performed at the optical axis change angle Φ (Φ=Φ1+Φ2) during time tb to time t6. This enables the optical axis change in accordance with the change in the vehicle attitude even in the state of the first optical axis 23ab. Thereafter, steps S5 and S6 are executed in a similar manner to the above one.

### [1-3. Effects, Etc.]

As described above, the imaging system 1 includes the imaging device 11 disposed in the vehicle 3, the imaging device performing imaging in the first imaging state C1 and the second imaging state C2 of different optical axes, the attitude detector 33 that detects the attitude state of the vehicle 3, the optical axis changing assembly 12 that changes, while the vehicle 3 is moving in the first direction, the optical axis of the imaging device 11 from the state of the first optical axis 23ab at the time when the imaging device 11 performs imaging in the first imaging state C1 to the state of the second optical axis 23ac inclined in the second direction intersecting the first direction at the time of imaging in the second imaging state C2, and the controller 15 that sets the optical axis change amount by which the optical axis changing assembly 12 changes the optical axis of the imaging device 11, based on the attitude change amount. The optical axis changing assembly 12 changes the optical axis of the imaging device 11 based on the set optical axis change amount.

In the vehicle 3 that is moving, the range of an image to be captured can be expanded in a direction intersecting the traveling direction by changing the optical axis of the imaging device 11 to the states of two or more optical axes. By changing the optical axis of the imaging device 11 in accordance with the change in the attitude state, it is possible to prevent the imaging range from being shifted due to the attitude change of the imaging device 11 that is displaced together with the vehicle 3, and to ensure the continuity of captured images.

Further, in the first optical axis change, the controller 15 causes the optical axis changing assembly 12 to change the optical axis of the imaging device 11 from the state of the first optical axis 23ab to the state of the second optical axis 23ac or from the state of the second optical axis 23ac to the state of the first optical axis 23ab between consecutive two imaging timings, for example, between an imaging timing at the exposure time Tp1 and an imaging timing at the exposure time Tp2, or between an imaging timing at the exposure time Tp2 and an imaging timing at the exposure time Tp3. This makes it possible to acquire a captured image where the imaging range is expanded.

In the first optical axis change, the controller 15 causes the optical axis changing assembly 12 to change the optical axis of the imaging device 11 between the state of the first optical axis 23ab and the state of the second optical axis 23ac by the first optical axis change angle Ø1 as the optical axis change amount for expanding the imaging range of a captured image.

The controller 15 does not issue the instruction of the second optical axis change while the optical axis changing assembly 12 is making the first optical axis change, and issues the instruction of the second optical axis change until the optical axis changing assembly 12 makes a next first optical axis change after completing the first optical axis change.

Further, the attitude detector 33 detects the attitude change amount of the vehicle 3 in the roll direction, and the controller 15 changes, as the optical axis change amount, the sum of the second optical axis change angle Φ2 and the first optical axis change angle Φ1 in the second optical axis change, the second optical axis change angle being opposite in sign to and equal in magnitude to the attitude change amount γ detected by the attitude detector 33.

### Second Embodiment

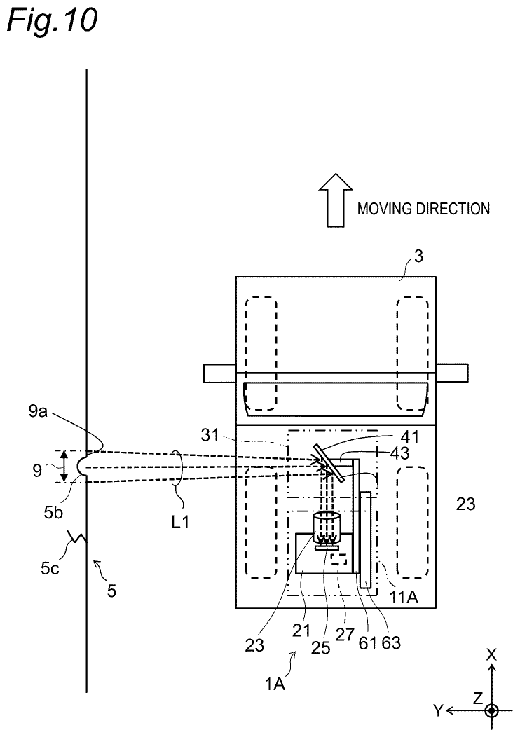

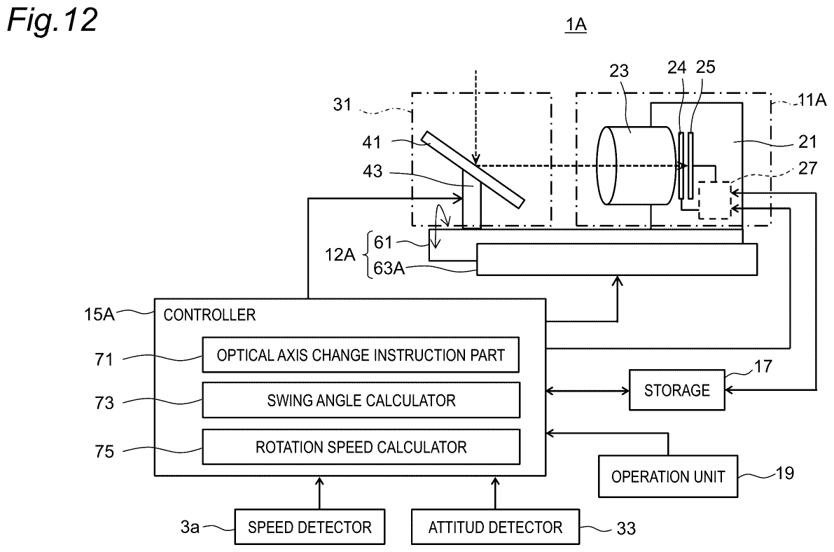

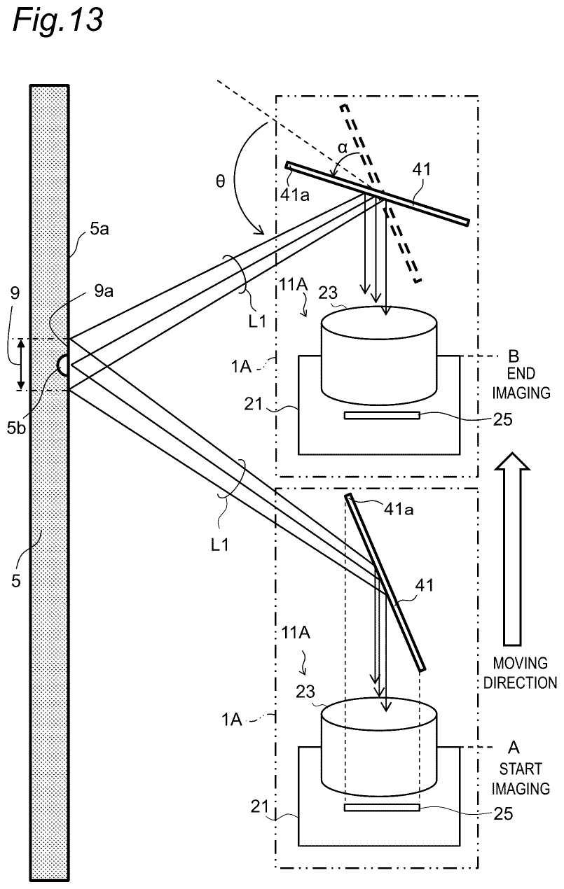

An imaging system 1A according to a second embodiment will be described with reference to FIGS. 10 to 15F. FIG. 10 is an explanatory diagram for explaining the vehicle 3 including the imaging system 1A according to the second embodiment. FIG. 12 is a block diagram illustrating an internal configuration of the imaging system 1A according to the second embodiment. FIG. 13 is an explanatory diagram for explaining a blur correction of the imaging system 1A.

The imaging system 1A in the second embodiment has a configuration where the imaging system 1 of the first embodiment includes a blur correction assembly 31. The points of the configuration other than the above-described point and points described below are common between the imaging system 1A according to the second embodiment and the imaging system 1 according to the first embodiment.

As illustrated in FIG. 10, for example, when the vehicle 3 travels in a tunnel, the hole 5b or the crack 5c, for example, is generated in the wall surface 5a in the tunnel. In the case of imaging in dark ambient light, such as in the tunnel, extending the exposure time causes a blur in a captured image. Further, in a case where the image of a subject is captured while the vehicle 3 is traveling at a high speed, a blur occurs in a captured image. The blur correction assembly 31 corrects the optical path of light injected to the imaging system 1A so as to reduce the blur in the image of the imaging target region 9 even if the imaging device 11A performs imaging while the vehicle 3 is moving.

The camera body 21 is disposed in the vehicle 3 so that the direction of the lens 23 is parallel to the moving direction of the vehicle 3. For example, the camera body 21 is disposed so that the lens 23 faces forward or backward of the vehicle 3.

The blur correction assembly 31 corrects the optical path of light L1, which is the ambient light reflected by the imaging target region 9, in accordance with the movement of the vehicle 3. The blur correction assembly 31 matches the direction of the light L1, which is the ambient light reflected by the imaging target region 9, with the imaging direction of the imaging element 25. The blur correction assembly 31 includes, for example, a mirror 41 and a mirror drive 43. The mirror 41 totally reflects the light, which is the ambient light reflected by the imaging subject, toward imaging device 11.

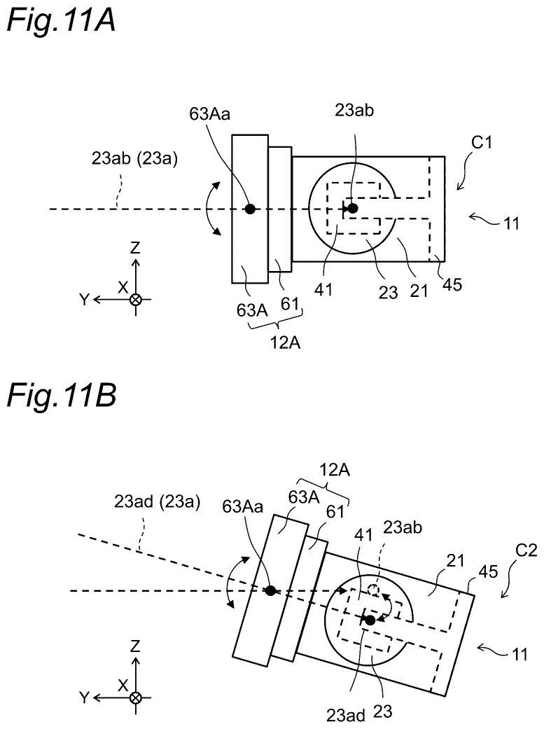

As illustrated in FIG. 11A, when the imaging device 11 performs imaging while the vehicle 3 is moving in the first direction that is the +X-axis direction, the optical axis changing assembly 12A changes the optical axis 23a of the lens 23 of the imaging device 11 capturing the first image, from the first optical axis 23ab to the second optical axis 23ad at the time of capturing the second image as illustrated in FIG. 11B. The first optical axis 23ab directs perpendicularly toward the wall 5 of the tunnel at the time of capturing the first image. The second optical axis 23ad is inclined in the second direction that is the +Z-axis direction intersecting the first direction at the time of capturing the second image. The rotation drive 63A of the optical axis changing assembly 12A rotates both the blur correction assembly 31 supported by the base 61 around a rotation shaft 63Aa and the imaging device 11B.

The blur correction assembly 31 and the optical axis changing assembly 12A are not limited to this configuration, and may use a pan-tilt rotation assembly that rotates the camera body 21 and the lens 23 around the rotation shaft in a case where the imaging device 11A has a configuration where the camera body 21 and the lens 23 are integrated. In this case, the blur correction assembly 31 corresponds to an assembly that rotationally drives the camera body 21 and the lens 23 in the pan direction, and the optical axis changing assembly 12 corresponds to an assembly that rotationally drives them in the pan direction.

Note that which of the driving assembly in the pan direction and the driving assembly in the tilt direction is made to correspond to the blur correction assembly 31 and the optical axis changing assembly 12A may be appropriately changed depending on the direction of the imaging element 25 and the direction of an imaging target with respect to the traveling direction of the vehicle 3. In the second embodiment, in a case where the traveling direction (+X-axis direction) of the vehicle 3 on a captured image and the long side of the imaging element 25 are parallel to each other, the imaging region in the traveling direction of the vehicle 3 can be expanded with emphasis on the overlapping region between captured images. In a case where the traveling direction (+X-axis direction) of the vehicle 3 on a captured image and the short side of the imaging element 25 are parallel to each other, the imaging range in the direction intersecting the traveling direction of the vehicle 3 is emphasized. However, the driving assembly in the pan direction may correspond to the optical axis changing assembly 12, and the driving assembly in the tilt direction may correspond to the blur correction assembly 31.

In a case where an assembly that rotates the camera body 21 and the lens 23 in one axis direction is provided, the assembly that causes the rotation in one axis direction may be used as the optical axis changing assembly 12A. In this case, the blur correction assembly 31 includes, for example, a mirror 41 and a mirror drive 43. The blur correction assembly 31 and the optical axis changing assembly 12A may be configured by two mirrors and motors. Their rotation axes are orthogonal to each other. The imaging device 11A may be entirely rotated in two orthogonal directions. Further, an assembly that rotationally drives the camera body 21 and the lens 23 in the tilt direction may be used as the optical axis changing assembly 12A, and an assembly that entirely rotates the imaging device 11A in the pan direction may be used as the blur correction assembly 31.

The mirror 41 is rotatably disposed to face the lens 23. For example, the mirror 41 is rotatable in both a clockwise, i.e. normal direction and a reverse direction, and the rotatable angular range may be less than 360 degrees or 360 degrees or more. The mirror 41 totally reflects the light, which is the ambient light reflected by the imaging subject, toward imaging device 11. The mirror drive 43 rotationally drives the mirror 41 from the initial angle to an instructed angle, and returns the mirror 41 to the initial angle again after rotating the mirror to the instructed angle. The mirror drive 43 is, for example, a motor.

The rotation angle of the mirror 41 is limited by the mechanical restriction of the mirror drive 43. The mirror 41 can be rotated to a maximum swing angle of the mirror 41 determined by this restriction.

With reference to FIG. 13, the blur correction made by the blur correction assembly 31 will be described. For example, it is assumed that the imaging system 1 located at a position A moves to a position B during the exposure time together with the vehicle 3. It is assumed that imaging is started at the position A and an image is acquired at this timing. In the image acquired at the position A, for example, the hole 5b of the imaging target region 9 is imaged, but due to insufficient exposure time, the image is dark and unclear.

Therefore, the exposure is continued until the vehicle 3 moves to the position B. In this case, if no blur correction is made, the imaging target region 9 relatively moves in the direction opposite to the moving direction of the vehicle 3, thereby obtaining the image in which the hole 5b is relatively moved. In the image in which the exposure is continued, the movement amount of pixels is detected as the blur amount. As described above, the image captured by the imaging device 11 while the vehicle 3 is moving becomes a blurred image.

Therefore, according to the moving speeds of the imaging system 1A and the vehicle 3, the mirror 41 is rotated in the direction where an end 41a of the mirror 41 on the moving direction side offsets the relative movement of the imaging target during the exposure time. This enables the imaging system 1 to image the same imaging target region 9 in the captured image during the exposure time, and to acquire an image in which the blur is greatly reduced. In FIG. 13, the mirror 41 is rotated clockwise so that the end 41a of the mirror 41 on the moving direction side turns toward the imaging target side during the exposure time. By rotating the mirror 41, the movement amount of the pixels in the captured image is corrected to 0.

FIG. 12 is referred to. A controller 15A includes the optical axis change instruction part 71, a swing angle calculator 73, and a rotation speed calculator 75.

The swing angle calculator 73 calculates a mirror swing angle α of the mirror 41 during imaging in the following flow based on the moving speed V of the vehicle 3, the set exposure time Tp, a subject magnification M, and the focal length F of the lens 23. The mirror swing angle α corresponds to the correction assembly swing angle.

The focal length F is a value determined by the lens 23. The subject magnification M is a value determined by the focal length F and the subject distance. The subject distance is a distance from the principal point 23b of the lens 23 to an imaging target, which is a subject. The lens is disposed between the imaging target and the imaging element 25. As the subject distance, a known value measured in advance may be used, or a value measured by a distance meter during imaging may be used.

A movement amount L of the vehicle 3 that has moved during the exposure time Tp from the imaging start time to the imaging end time is calculated based on the moving speed V and the exposure time Tp according to the following Equation (3).

$$L [ mm ] = V [ km / h ] \times 1 {0}^{6} \times Tp [ ms ] / ( {60}^{2} \times 1 {0}^{3} ) \qquad Equation ( 3 )$$

A movement amount P of the pixel on the imaging element 25 from the imaging start time to the imaging end time is calculated based on the movement amount L of the vehicle 3 and the subject magnification M according to the following Equation (4).

$$P [ mm ] = L [ mm ] \times M \qquad Equation ( 4 )$$

Since the movement amount P of the pixel causes a blur, the optical path of the light projected to the lens 23 is changed by a blur correction angle θ in accordance with the movement amount P of the pixel so that the blur does not occur. The blur correction angle θ is calculated based on the movement amount P of the pixel and the focal length F according to the following Equation (5).

$$θ [ deg ] = arctan ( P / F ) \qquad Equation ( 5 )$$

As described above, the subject magnification M is calculated based on the focal length F [mm] and the subject distance D [m] according to the following Equation (6).

$$M = F / ( D \times 1 {0}^{3} ) \qquad Equation ( 6 )$$

According to Equations (3), (4), (5), and (6),

$$θ = arctan ( V \times 1 {0}^{6} \times Tp / ( {60}^{2} \times 1 {0}^{3} ) / ( D \times 1 {0}^{3} ) ) = arctan ( V \times Tp / ( D \times 6 {0}^{2} ) ) \qquad Equation ( 7 )$$

In such a manner, the blur correction angle θ is calculated based on the moving speed V, the exposure time Tp, and the subject distance D.

Since the mirror swing angle α necessary for a blur correction during exposure is half the blur correction angle θ, the mirror swing angle α is calculated according to the following Equation (8).

$$α = θ / k \qquad Equation ( 8 )$$

Here, k represents a coefficient of conversion between the mirror swing angle α as an assembly swing angle of the driving assembly and the blur correction angle θ as an optical correction angle at which light incident to the lens 23 is corrected. In a case of the configuration in which light from an imaging target travels through the mirror 41, the lens 23, and the imaging element 25 in this order as in the embodiment of FIG. 12, k=2. Further, in the case of the configuration including the pan-tilt assembly and the entire camera driving assembly, k=1.

In this manner, the swing angle calculator 73 calculates the mirror swing angle α of the mirror 41.

The rotation speed calculator 75 calculates a rotation speed Vm of the mirror 41 during the exposure period according to the following equation based on the mirror swing angle α and the exposure time Tp.

$$Vm = α / Tp 1 \qquad Equation ( 9 )$$

Therefore, by rotating the mirror 41 in the direction opposite to the moving direction at the rotation speed Vm after the start of imaging, the imaging device 11A can receive the light from the same imaging target region 9 during the exposure time, and can suppress the occurrence of a blur in the captured image.

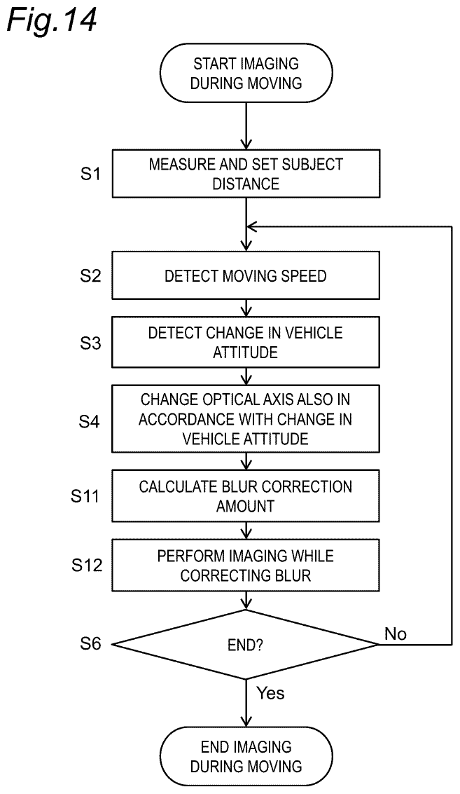

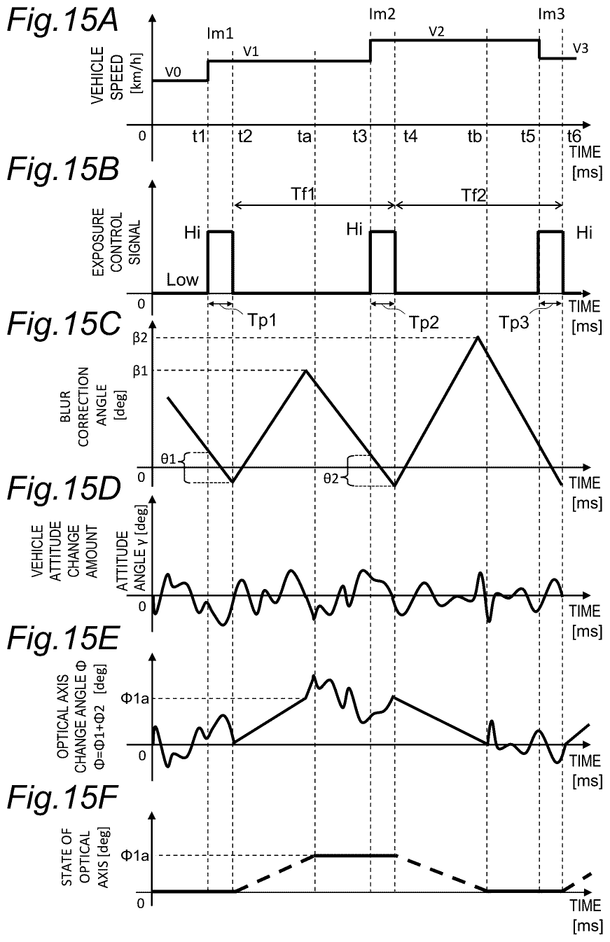

The operation of the imaging system 1A will be described below with reference to FIGS. 14 and 15A-15B. FIG. 14 is a flowchart illustrating imaging processing performed by the imaging system 1A. FIG. 15A-15F are graphs illustrating a relationship between the exposure time, the blur correction angle, and the optical axis change angle. FIG. 15A is the graph illustrating the moving speed of the vehicle 3. The moving speed changes with the lapse of time. FIG. 15B is the graph illustrating the timing of the exposure time at each frame. FIG. 15C is the graph illustrating a change in the blur correction angle over time. The blur correction assembly 31 rotates the optical axis for blur correction through the blur correction angle. FIG. 15D is the graph illustrating the attitude change amount of the vehicle 3 detected by the attitude detector 33. FIG. 15E is the graph illustrating the optical axis change amount instructed by the optical axis change instruction part 71 to the rotation drive 63. FIG. 15F is the graph illustrating a position of the optical axis of the imaging device 11A rotated by the rotation drive 63. The imaging processing illustrated in FIG. 14 is started, for example, when the instruction to start imaging is issued from the operation unit 19 while the vehicle 3 is moving.

Steps S1 to S4 are similar to the operation of the imaging system 1 in the first embodiment, and thus description thereof is omitted. In step S11, the swing angle calculator 73 calculates the mirror swing angle α as the blur correction amount. The rotation speed calculator 75 calculates the rotation speed Vm of the mirror 41 based on the mirror swing angle α.

In step S12, the controller 15A causes the mirror drive 43 to rotate the mirror 41 at the calculated rotation speed Vm, and the mirror 41 starts to rotate from a predetermined initial angle. As a result, the blur correction during the imaging of the imaging device 11A is made. At the same time, the controller 15A continues to send the optical axis change signal in accordance with the change in the vehicle attitude. Thus, the attitude change of the imaging device due to the change in the vehicle attitude is canceled, and the optical axis position is maintained at a constant position. In this state, the controller 15A continues sending a Hi signal instructing exposure to the camera controller 27 during the exposure time Tp.

In the imaging device 11A, the camera controller 27 acquires an image by opening the shutter 24 to perform exposure while receiving the Hi signal, and stores the acquired image in the storage 17. When the exposure time Tp has elapsed, the controller 15A continues sending, to the camera controller 27, a Low signal as an OFF signal instructing to stop exposure. Note that a Low signal may be used as an ON signal instructing exposure, and a Hi signal may be used as an OFF signal instructing to stop exposure.

While the camera controller 27 is receiving the Low signal, the shutter 24 is closed, and the controller 15A causes the mirror drive 43 to rotate the mirror 41 backward to return the mirror 41 to the initial angle. The mirror drive 43 may rotate the mirror 41 in the normal direction to return the mirror 41 to the initial angle.

In a case where images are consecutively captured, the operation of the imaging system 1A after returning to step S2 will be described with reference to FIG. 15A-15F.

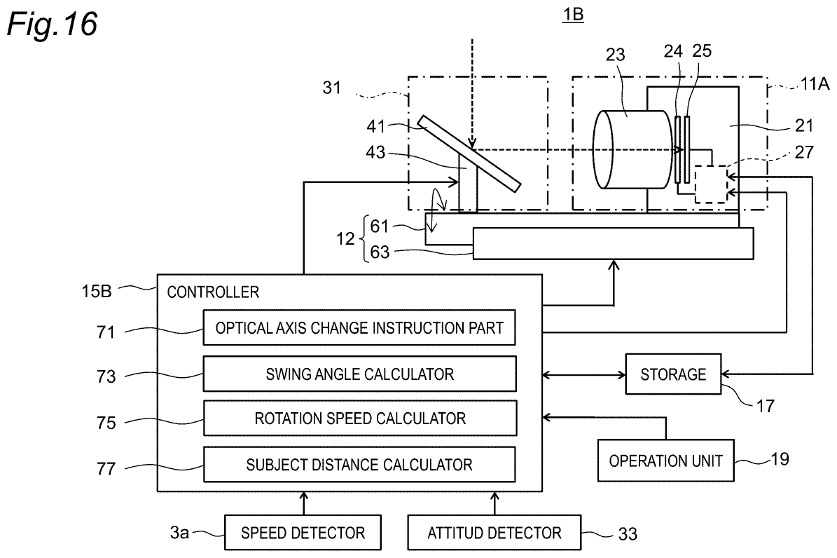

In synchronization with the timing when the vehicle speed is detected, a Hi signal indicating an imaging instruction is transmitted, and a first image is captured. At this time, a blur correction angle of the next frame is calculated by using the speed of the vehicle 3 detected by the speed detector 3a. When the capturing of the first image ends, the optical axis change instruction part 71 of the controller 15A instructs the optical axis changing assembly 12A to change the optical axis as the first optical axis change. While the optical axis is being changed, the mirror drive 43 drives the mirror 41 to a rotation start angle β1 which is a start position of rotation in a blur correction direction. Since the first optical axis change and the driving of the mirror 41 to the rotation start angle may be completed by the start of exposure, the completion timing of the first optical axis change may be asynchronous with respect to the completion timing of the driving of the mirror 41 to the rotation start angle. Since the part (c) of FIG. 16 shows the blur correction angle which is an optical angle, a mirror mechanical angle in the case of using the mirror 41 is half the rotation start angles β1 and β2 in the correction direction because k=2 in Equation (8) as described above.

When the optical axis is driven by the first optical axis change angle Φ1 from the state of the first optical axis 23ab to the state of the second optical axis 23ad, the optical axis change instruction part 71 instructs the rotation drive 63 of the optical axis changing assembly 12A to cause a rotate (the second optical axis change) in a direction where the attitude change amount of the imaging device due to the vehicle attitude change is offset. As a result, as illustrated in FIG. 15F, the optical axis can be maintained in the state of the second optical axis 23ad even when the attitude of the vehicle 3 changes.

In this state, the mirror drive 43 starts to rotate the mirror 41 at the rotation speed calculated by the rotation speed calculator 75. While the first optical axis change is completed and the second optical axis change is made, the controller 15A transmits a Hi signal indicating the imaging instruction to the camera controller 27. As a result, the imaging device 11A captures an image. At this time, the second image is subjected to the blur correction at the blur correction angle θ1 in accordance with the speed V0 at the time of capturing the previous image, and the third image is subjected to the blur correction at the blur correction angle θ2 in accordance with the speed V1 at the time of capturing the second image. The blur correction angle of the fourth image may be calculated in accordance with an average speed of the speed V1 at the time of capturing the second image and the speed V2 at the time of capturing the third image.

As described above, the imaging system 1A of the second embodiment includes the speed detector 3a that detects the moving speed of the vehicle 3, and the blur correction assembly 31 that corrects a blur in the first direction that is the moving direction of the vehicle 3 when the imaging device 11A performs imaging while the vehicle 3 is moving. The controller 15A sets the blur correction angle for blurring correction by the blur correction assembly 31 based on the moving speed, and changes the blur correction angle based on the optical axis change amount.

The imaging range can be expanded in the direction intersecting the traveling direction while the blur correction in the moving direction is being made in accordance with the moving speed of the vehicle 3. Therefore, an image of a wide range with high resolution can be acquired. Further, since the attitude of the imaging device 11A is corrected in accordance with the attitude variation of the vehicle 3 in the direction where the imaging range is expanded, the continuity between a plurality of captured images can be secured.

### Third Embodiment

An imaging system 1B according to a third embodiment will be described with reference to FIG. 16. FIG. 16 is a block diagram illustrating an internal configuration of the imaging system 1B according to the third embodiment.

The imaging system 1B in the third embodiment has a configuration where the controller 15A of the imaging system 1A in the second embodiment includes a subject distance calculator 77. The points of the configuration other than the above-described point and points described below are common between the imaging system 1B according to the third embodiment and the imaging system 1A according to the second embodiment.

The imaging system 1B in the third embodiment calculates the blur correction amount in accordance with the subject distance that varies as the optical axis is displaced. The controller 15B of the imaging system 1B includes the subject distance calculator 77.

The subject distance calculator 77 calculates the subject distance in the state of the second optical axis 23ad when the optical axis is displaced from the state of the first optical axis 23ab, which is the initial position, to the state of the second optical axis 23ad. A method for calculating the subject distance in the state of the second optical axis 23ad will be described with reference to FIG. 4A-4B and FIG. 7A-7B. In FIGS. 7A and 7B, the second optical axis indicated by reference symbol 23ac will be described here as the second optical axis 23ad. A second subject distance D2 to the imaging target in the state of the second optical axis 23ad and a third subject distance D3 are calculated in the following manner. The second optical axis 23ad is the optical axis of the lens 23 changed through the optical axis change angle Φ from the state of the first optical axis 23ab directing perpendicularly toward the imaging target. The third subject distance D3 is an outer edge of the optical path at the angle of view a on the second optical axis 23ae. The subject distance D3 is a length of a perpendicular line extending down from the end of the optical path at the angle of view a to the imaging surface after the optical axis change.

The second subject distance D2 is calculated according to the following Equation (10).

$$D 2 = D 1 / cos ( Φ ) \qquad Equation ( 10 )$$

For example, under the condition of the first embodiment, D2 is 1.706 [m].

The third subject distance D3 is calculated according to the following Equation (11).

$$D 3 = D 1 / cos \{ Φ + ( a / 2 ) \} \times sin ( 90 - Φ ) \qquad Equation ( 11 )$$

For example, under the condition of the first embodiment, D3 is 1.73 [m].

Using the second subject distance D2 calculated in this manner, the subject magnification M2 in the state of the second optical axis 23ad is calculated. The subject magnification is substituted into Formula (4), thereby calculating the movement amount P2 of the pixel in the state of the second optical axis 23ad. The mirror swing angle α can be calculated according to Equations (5) and (8) using the movement amount P2 of the pixel.

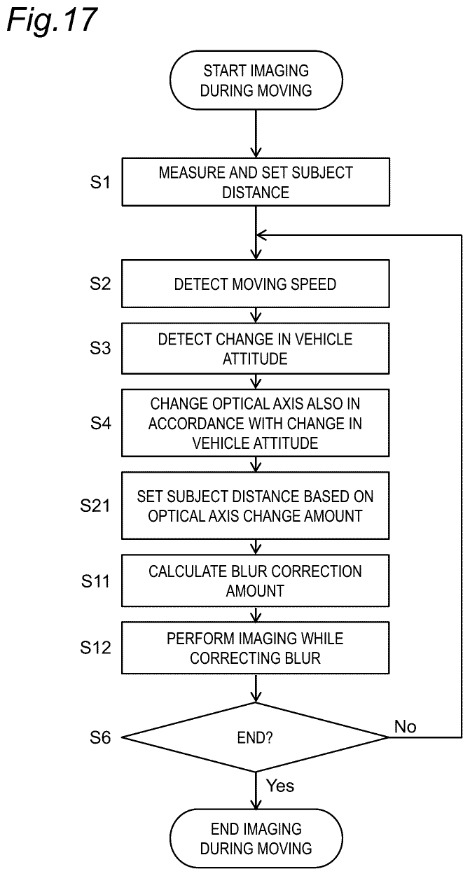

An operation of the imaging system 1B in the third embodiment will be described with reference to FIG. 17. FIG. 17 is a flowchart illustrating imaging processing in the third embodiment. As for the operation of the imaging system 1B in the third embodiment, step S21 is added to the operation of the imaging system 1A in the second exemplary embodiment.

Steps S1 to S4, S11, S12, and S6 are similar to the operation of the imaging system 1A in the second embodiment, and thus description thereof is omitted. After the optical axis change in step S4, in step S21, the subject distance calculator 77 calculates the subject distance based on the optical axis change angle Φ and newly sets the calculated subject distance. As a result, in step S11, the accuracy of the correction assembly swing angle (blur amount) calculated by the swing angle calculator 73 can be improved.

The controller 15B calculates the subject distance from the imaging device 11A to the imaging target region 9 based on the optical axis change angle changed by the optical axis changing assembly 12. The subject distance changes before and after the optical axis change. The controller 15B then sets the blur correction angle for correcting the blur in the moving direction of the vehicle 3, based on the subject distance. As a result, more accurate tracking can be achieved, and the blur correction can be made with high accuracy.

### Fourth Embodiment

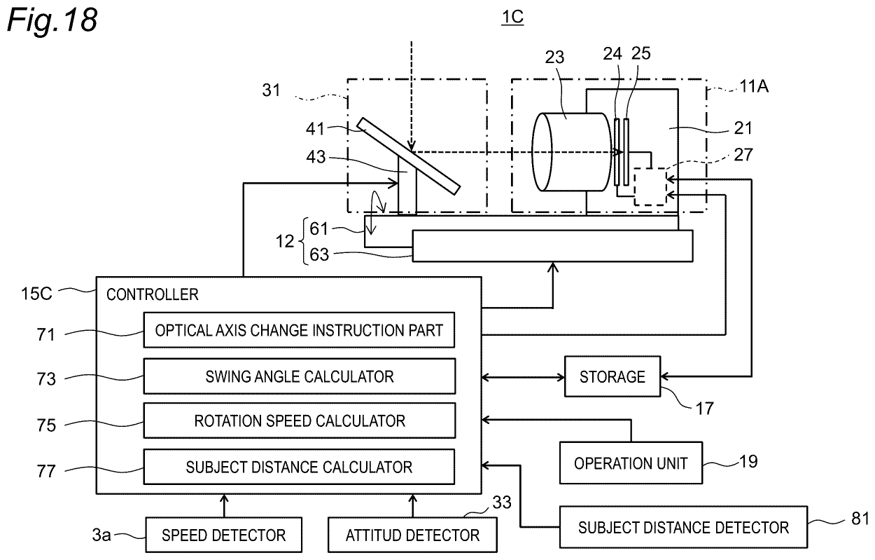

An imaging system 1C according to a fourth embodiment will be described with reference to FIG. 18. FIG. 18 is a block diagram illustrating an internal configuration of the imaging system 1C according to the fourth embodiment.

The imaging system 1C in the fourth embodiment has a configuration where the imaging system 1B in the third embodiment includes a subject distance detector 81. The points of the configuration other than the above-described point and points described below are common between the imaging system 1C according to the fourth embodiment and the imaging system 1B according to the third embodiment.

The subject distance detector 81 detects the subject distance from the principal point of lens 23 to a subject. The subject distance detector 81 is, for example, a laser measuring instrument. Information about the subject distance detected by the subject distance detector 81 is sent to a controller 15C. The swing angle calculator 73 of the controller 15C calculates the swing angle of the correction assembly in the state of the first optical axis 23ab based on the detected first subject distance D1.

By detecting the subject distance from the principal point of the lens 23 to the subject, the subject distance detector 81 can accurately calculate the blur correction amount even if the height of the imaging device 11A from the road surface of the road 4 is changed in accordance with a situation of a site. As a result, the imaging range of the imaging device 11A can be easily adjusted by adjusting the subject distance between the imaging device 11A and the subject. Even in a case where the subject distance changes during traveling in the imaging of the wall surface 5a on the side of the tunnel and the imaging of the road surface when the vehicle inclination changes due to traveling on a slope, the blur correction amount can be accurately calculated based on the detected subject distance.

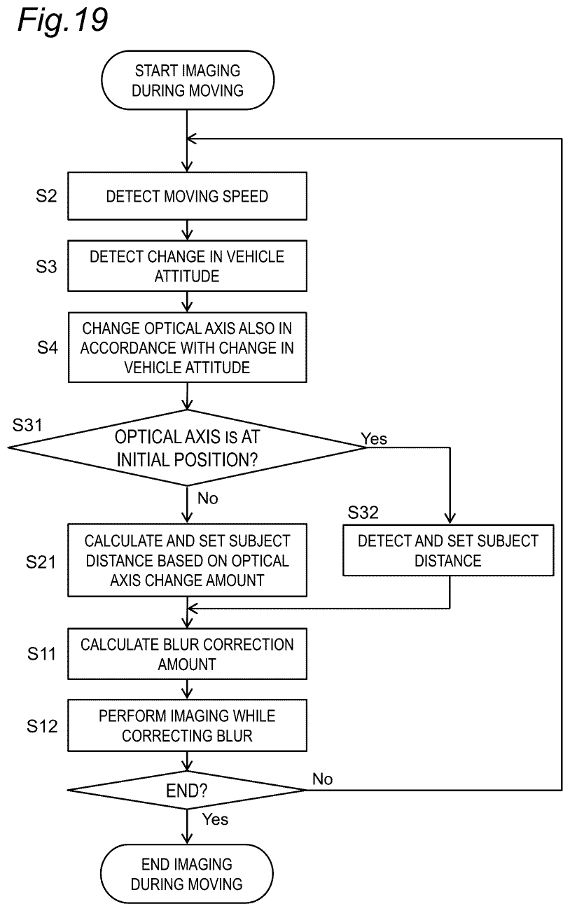

An operation of the imaging system 1C in the fourth embodiment will be described with reference to FIG. 19. FIG. 19 is a flowchart illustrating imaging processing in the fourth embodiment. In the operation of the imaging system 1C in the fourth embodiment, step S1 is omitted from and steps 31 and 32 are added to the operation of the imaging system 1B in the third embodiment.

In the imaging system 1C according to the fourth embodiment, instead of measuring the subject distance in advance, the subject distance detector 81 measures the first subject distance D1 when the optical axis is in the state of the first optical axis 23ab which is the initial position.

After the optical axis change in step S4, in step 31, the controller 15C determines whether the optical axis is in the state of the first optical axis 23ab which is the initial position. When the controller 15C determines that the optical axis is in the state of the first optical axis 23ab (Yes in step S 31), in step S32, the subject distance detector 81 detects the first subject distance D1, and the controller 15C sets this detection value as the subject distance in the state of the first optical axis 23ab. As a result, in step S11, the accuracy of the correction assembly swing angle calculated by the swing angle calculator 73 can be improved.

When the controller 15C determines that the optical axis is in the state of the second optical axis 23ad (No in step S 31), in step S21, the subject distance calculator 77 calculates the subject distance based on the first optical axis change angle Φ, and newly sets the calculated subject distance. As a result, in step S11, the accuracy of the correction assembly swing angle calculated by the swing angle calculator 73 can be improved.

As described above, the imaging system 1C includes the subject distance detector 81 that measures the subject distance from the imaging device 11A to the imaging target region 9, thereby calculating the blur correction angle accurately.

Further, the controller 15C causes the subject distance detector 81 to perform the subject distance detection in the state of the first optical axis 23ab before the optical axis change, and to calculate the subject distance based on the first subject distance D1 and the first optical axis change angle Φ1. The first subject distance D1 is detected in the state of the first optical axis 23ab after the optical axis is changed to the state of the second optical axis 23ad by the optical axis changing assembly 12. The first optical axis change angle Φ1 is the optical axis change amount.

The subject distance detector 81 detects the subject distance when the optical axis is at the initial position. As a result, when the optical axis is changed obliquely upward with respect to the time of imaging the wall surface 5a of the tunnel immediately above, erroneous detection of the distance can be prevented in a case where a vehicle, such as a trailer, having a high height in an adjacent lane enters the subject distance detection range. Further, in the case of imaging the road surface, erroneous detection of the distance can be prevented in the case where the vehicle in the adjacent lane enters the subject distance detection range by changing the optical axis from the time of imaging the road surface just below. A distance meter is installed on the wall surface 5a on the side of the tunnel above the height of a general vehicle to be able to detect the distance. This makes it possible to prevent the vehicle in the adjacent lane from becoming a cause of erroneous detection at the time when the optical axis is changed downward.

### Other Embodiments

The above embodiments have been described as the examples of the technique disclosed in this application. However, the technique in the present disclosure is not limited to them, and is applicable to embodiments in which changes, replacements, additions, omissions, etc. are made as appropriate. Therefore, other embodiments will be exemplified below.

In the above embodiments, the optical axis of the imaging device 11 has the states of two optical axes, the state of the first optical axis 23ab and the state of the second optical axis 23ac, but the present disclosure is not limited thereto. The imaging device 11 has states of three or more optical axes. The optical axis changing assembly 12 may displace the imaging device 11 to the respective states of optical axes. The imaging device 11 then may image an imaging target in the respective states of optical axes.

In the above embodiments, the information about the moving speed V1 from the speed detector 3a of the vehicle 3 is used, but the present disclosure is not limited thereto. The imaging system 1 may include a speed detector that detects the moving speed of the imaging system 1. The speed detector may use a global positioning system (GPS).

In the above embodiments, the imaging system 1 images the wall surface on the side of the vehicle 3, but the present disclosure is not limited thereto. The imaging system 1 may image wall surfaces on upper and lower sides with respect to the vehicle 3.

The above embodiments have described the case where the mobile object is the vehicle 3 such as an automobile. However, the mobile object is not limited to the vehicle 3, and may be a vehicle traveling on the ground such as a train or a motorcycle, a ship traveling on the sea, or a flying object such as an airplane or a drone flying in the air. In a case where the mobile object is a ship, the imaging system 1 images a wall surface of a bridge pier or bridge girder, or a structure constructed along a coast. In a case where the mobile object is a train, the position and wear of wiring can be detected by imaging the wiring.

In the above embodiments, the image is captured by the light which is ambient light reflected by the imaging target region 9, but the present disclosure is not limited thereto. The imaging target region 9 may be irradiated with light from the mobile object or the imaging system, and an image by reflected light of the irradiated light may be captured.

### Outline of Embodiments

(1) An imaging system of the present disclosure includes an imaging device disposed in a mobile object, the imaging device performing imaging in a first imaging state and a second imaging state of different optical axes, an attitude detector that detects an attitude change amount of the mobile object, an optical axis changing assembly that changes, while the mobile object is moving in a first direction, an optical axis of the imaging device from a state of a first optical axis at a time when the imaging device performs imaging in the first imaging state to a state of a second optical axis inclined in a second direction intersecting the first direction at a time of imaging in the second imaging state, and a controller that sets the optical axis change amount by which the optical axis changing assembly changes the optical axis of the imaging device, based on the attitude change amount. The optical axis changing assembly changes the optical axis of the imaging device based on the set optical axis change amount.

As a result, the imaging system can expand the imaging range, can capture an image of a wide range, and changes the optical axis of the imaging device in accordance with the attitude variation of the mobile object. Therefore, the state of the first optical axis and the state of the second optical axis can be stably maintained, and the continuity of the captured image can be secured.

(2) In the imaging system in (1), the controller instructs the optical axis changing assembly to make a change to two types of optical axes, a first optical axis change for expanding the imaging range of a captured image and a second optical axis change for reducing an influence of the attitude change of the mobile object.

(3) In the imaging system in (2), the controller causes the optical axis changing assembly to change the optical axis of the imaging device from the state of the first optical axis to the state of the second optical axis or from the state of the second optical axis to the state of the first optical axis between two consecutive imaging timings in the first optical axis change.

(4) In the imaging system in (3), the controller causes the optical axis changing assembly to change the optical axis of the imaging device between the state of the first optical axis and the state of the second optical axis in the first optical axis change by a first optical axis change angle for expanding the imaging range of a captured image as the optical axis change amount.

(5) In the imaging system in any one of (2) to (4), the controller does not issue an instruction of the second optical axis change while the optical axis changing assembly is making the first optical axis change, and issues the instruction of the second optical axis change until the optical axis changing assembly makes a next first optical axis change after completing the first optical axis change.

(6) In the imaging system in (4), the attitude detector detects the attitude change amount of the mobile object in a roll direction, and the controller changes, as the optical axis change amount, a sum of the second optical axis change angle and the first optical axis change angle in the second optical axis change, the second optical axis change angle being opposite in sign to and equal in magnitude to the attitude change amount detected by the attitude detector.

(7) The imaging system in (1) to (6) further includes a speed detector that detects a moving speed of the mobile object, and a blur correction assembly that corrects a blur in the first direction at the time when the imaging device performs imaging while the mobile object is moving, wherein the controller sets a blur correction angle for a blur correction with the blur correction assembly based on the moving speed, and changes the blur correction angle based on the optical axis change amount.

(8) In the imaging system in (7), the controller calculates a subject distance from the imaging device to an imaging target region based on an optical axis change angle changed by the optical axis changing assembly, the subject distance being changed before and after an optical axis change, and sets at blur correction angle for correcting the blur in the first direction, based on the subject distance.

(9) The imaging system in (8) further includes a subject distance measurement device that measures the subject distance from the imaging device to the imaging target region.

(10) In the imaging system in (9), the subject distance measurement device detects a subject distance in the state of the first optical axis before the optical axis change, and calculates a subject distance based on the subject distance detected in the state of the first optical axis after the optical axis changing assembly changes the optical axis to the state of the second optical axis and the optical axis change amount.

(11) In the imaging system in (4), the controller does not issue an instruction of the second optical axis change while the optical axis changing assembly is making the first optical axis change, and issues the instruction of the second optical axis change while the imaging device is performing exposure.

(12) A mobile object of the present disclosure includes the imaging system in any one of (1) to (10). As a result, while the mobile object is moving, the imaging system can expand the imaging range, can capture an image of a wide range, and changes the optical axis of the imaging device in accordance with the attitude variation of the mobile object. Therefore, the state of the first optical axis and the state of the second optical axis can be stably maintained, and the continuity of the captured image can be secured.

The present disclosure is applicable to an imaging system installed in a moving mobile object.

### EXPLANATIONS OF LETTERS OR NUMERALS

1, 1A, 1B, 1C Imaging system
3 Vehicle
3a Speed detector
4 Road
4b Hole
4c Crack
5 Wall
5a Wall surface
5b Hole
5c Crack
9 Imaging target region
11 Imaging device
12 Optical axis changing assembly
15 Controller
17 Storage
19 Operation unit
21 Camera body
23 Lens
23a Optical axis
23ab First optical axis
23ac Second optical axis
24 Shutter
25 Imaging element
27 Camera controller
31 Blur correction assembly
33 Attitude detector
41 Mirror
43 Mirror drive
45 Arm
51 Maximum exposure time calculator
61 Base
63 Rotation drive
71 Optical axis change instruction part
73 Swing angle calculator
75 Rotation speed calculator
81 Subject distance detector
α Mirror swing angle
F Focal length
C1 First imaging state
C2 Second imaging state
M Subject magnification
LE1 Extension line of principal point of lens
LE2 Extension line of imaging target surface
Φ Optical axis change angle
Φ1 First optical axis change angle
Φ2 Second optical axis change angle
Tf1, Tf2 Capturing interval
V0, V1, V2, V3 Moving speed

What is claimed is:

1. An imaging system comprising:
an imaging device disposed in a mobile object, the imaging device performing imaging in a first imaging state and a second imaging state of different optical axes;
an attitude detector that detects an attitude change amount of the mobile object;
an optical axis changing assembly that changes, while the mobile object is moving in a first direction, an optical axis of the imaging device from a state of a first optical axis at a time when the imaging device performs imaging in the first imaging state to a state of a second optical axis inclined in a second direction intersecting the first direction at a time of imaging in the second imaging state; and
a controller that sets an optical axis change amount by which the optical axis changing assembly changes the optical axis of the imaging device, based on the attitude change amount,
wherein the optical axis changing assembly changes the optical axis of the imaging device based on the set optical axis change amount.

2. The imaging system according to claim 1,
wherein the controller instructs the optical axis changing assembly to make a change to two types of optical axes, a first optical axis change for expanding an imaging range of a captured image and a second optical axis change for reducing an influence of the attitude change of the mobile object.

3. The imaging system according to claim 2,
wherein the controller causes the optical axis changing assembly to change the optical axis of the imaging device from the state of the first optical axis to the state of the second optical axis or from the state of the second optical axis to the state of the first optical axis between two consecutive imaging and imaging in the first optical axis change.

4. The imaging system according to claim 3,
wherein the controller causes the optical axis changing assembly to change the optical axis of the imaging device between the state of the first optical axis and the state of the second optical axis in the first optical axis change by a first optical axis change angle for expanding the imaging range of a captured image as the optical axis change amount.

5. The imaging system according to claim 4,
wherein the controller does not issue an instruction of the second optical axis change while the optical axis changing assembly is making the first optical axis change, and issues the instruction of the second optical axis change until the optical axis changing assembly makes a next first optical axis change after completing the first optical axis change.

6. The imaging system according to claim 4,
wherein the attitude detector detects an attitude change amount of the mobile object in a roll direction, and
wherein the controller changes, as the optical axis change amount, a sum of a second optical axis change angle and the first optical axis change angle in the second optical axis change, the second optical axis change angle being opposite in sign to and equal in magnitude to the attitude change amount detected by the attitude detector.

7. The imaging system according to claim 1, further comprising:
a speed detector that detects a moving speed of the mobile object; and
a blur correction assembly that corrects a blur in a captured image along the first direction at the time when the imaging device performs imaging while the mobile object is moving,
wherein the controller sets a blur correction angle for a blur correction with the blur correction assembly based on the moving speed, and changes the blur correction angle based on the optical axis change amount.

8. The imaging system according to claim 7,
wherein the controller calculates a subject distance from the imaging device to an imaging target region based on an optical axis change angle changed by the optical axis changing assembly, the subject distance being changed before and after an optical axis change, and sets the blur correction angle for correcting the blur along the first direction, based on the subject distance.

9. The imaging system according to claim 8, further comprising
a subject distance measurement device that measures the subject distance from the imaging device to the imaging target region.

10. The imaging system according to claim 9,
wherein the controller causes the subject distance measurement device to detect the subject distance in the state of the first optical axis before the optical axis change, and calculates the subject distance based on the subject distance detected in the state of the first optical axis after the optical axis changing assembly changes the optical axis to the state of the second optical axis and the optical axis change amount.

11. The imaging system according to claim 4,
wherein the controller does not issue an instruction of the second optical axis change while the optical axis changing assembly is making the first optical axis change, and issues the instruction of the second optical axis change while the imaging device is performing exposure.

12. A mobile object comprising the imaging system according to claim 1.

13. The imaging system according to claim 2,
wherein the controller does not issue an instruction of the second optical axis change while the optical axis changing assembly is making the first optical axis change, and issues the instruction of the second optical axis change until the optical axis changing assembly makes a next first optical axis change after completing the first optical axis change.

14. The imaging system according to claim 3,
wherein the controller does not issue an instruction of the second optical axis change while the optical axis changing assembly is making the first optical axis change, and issues the instruction of the second optical axis change until the optical axis changing assembly makes a next first optical axis change after completing the first optical axis change.

15. The imaging system according to claim 2, further comprising:
a speed detector that detects a moving speed of the mobile object; and
a blur correction assembly that corrects a blur in the first direction at the time when the imaging device performs imaging while the mobile object is moving,
wherein the controller sets a blur correction angle for a blur correction with the blur correction assembly based on the moving speed, and changes the blur correction angle based on the optical axis change amount.

16. The imaging system according to claim 3, further comprising:
a speed detector that detects a moving speed of the mobile object; and
a blur correction assembly that corrects a blur in the first direction at the time when the imaging device performs imaging while the mobile object is moving,
wherein the controller sets a blur correction angle for a blur correction with the blur correction assembly based on the moving speed, and changes the blur correction angle based on the optical axis change amount.

17. The imaging system according to claim 4, further comprising:
a speed detector that detects a moving speed of the mobile object; and
a blur correction assembly that corrects a blur in the first direction at the time when the imaging device performs imaging while the mobile object is moving,
wherein the controller sets a blur correction angle for a blur correction with the blur correction assembly based on the moving speed, and changes the blur correction angle based on the optical axis change amount.

18. The imaging system according to claim 5, further comprising:
a speed detector that detects a moving speed of the mobile object; and
a blur correction assembly that corrects a blur in the first direction at the time when the imaging device performs imaging while the mobile object is moving,
wherein the controller sets a blur correction angle for a blur correction with the blur correction assembly based on the moving speed, and changes the blur correction angle based on the optical axis change amount.

19. The imaging system according to claim 6, further comprising:
a speed detector that detects a moving speed of the mobile object; and
a blur correction assembly that corrects a blur in the first direction at the time when the imaging device performs imaging while the mobile object is moving,
wherein the controller sets a blur correction angle for a blur correction with the blur correction assembly based on the moving speed, and changes the blur correction angle based on the optical axis change amount.
